(19) United States
(12) Patent Application Publication
(10) Pub. No.: US 2004/0140178 A1
(43) Pub. Date: Jul. 22, 2004

(54) Scraper chain conveyor for use in underground mining

(76) Inventors: Elmar Wiejack-Symann, Dinslaken (DE); Frank-Hasse Schmidt, Essen (DE)

Correspondence Address: Robert W Becker & Associates, Suite B, 707 Highway 66 East, Tijeras, NM, 87059, US

(21) Appl. No.: 10/475,817

(22) PCT Filed: Mar. 28, 2001
(86) PCT No.: PCT/DE01/01200

(30) Foreign Application Priority Data
Apr. 22, 2000 (DE) 100 20021.4

(51) Int. Cl. B65G 19/22

(52) U.S. Cl. 198/725; 198/735.1

(57) ABSTRACT

A drag chain conveyor is provided for use in underground mining, and comprises interconnected, profiled conveyor chutes, conveyor chains guided in the conveyor chutes, carriers attached to the conveyor chains, and at least one drive for the conveyor chains. The conveyor chains and/or the carriers are comprised at least partially of a self-extinguishing and difficult to ignite plastic or polymeric material having anti-static material properties and a high mechanical strength.

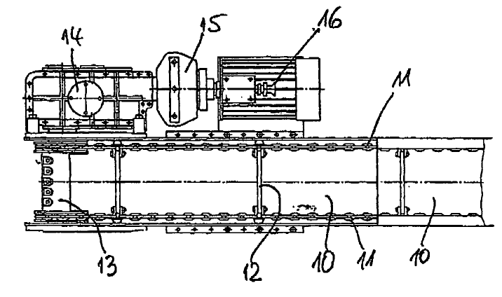

### RELATED APPLICATIONS

This application is a continuation of International Application Nr. PCT/DE01/01200 filed Mar. 28, 2001.

### BACKGROUND OF THE INVENTION

The present invention relates to a scraper or drag chain conveyor for use in underground mining, especially in hard or bituminous coal mining, and includes interconnected, profiled conveyor chutes or troughs in which are guided conveyor chains having carrier or engagement means connected to the chains, and also includes at least one drive means for the conveyor chains.

Drive chain conveyors of this general type, for example when used as face conveyors, are characterized, especially with today's customarily large face lengths, in that the conveyor chains, which are to be moved by the drive means of the drag chain conveyor, and the carrier means carried by the chains, represent a very considerable mass, for the movement of which increasingly greater drive capacities must be made available. In addition to the high energy requirement, the drive units that are necessary have a considerable overall size, so that the mine openings for the transport and assembly of such drive units also have to have correspondingly large dimensions, which leads to considerable costs.

It is therefore an object of the present invention, for a drag chain conveyor having the aforementioned general features, to reduce the masses that are to be moved by the pertaining drive means.

### BRIEF DESCRIPTION OF THE DRAWING

This object, and other objects and advantages of the present invention, will appear more clearly from the following specification in conjunction with the sole FIGURE of the drawing, which is a plan view of one exemplary embodiment of an inventive drag chain conveyor, and in particular in the region of its drive station.

### SUMMARY OF THE INVENTION

The basic concept of the drag chain conveyor of the present application is that the conveyor chains and/or carrier means are comprised at least partially of a self-extinguishing and difficult to ignite plastic or polymeric material having anti-static material properties and a high mechanical strength or stability.

The drag chain conveyor of the present application has the advantage that due to the reduction in weight, which is connected with the use of polymeric material as the material for the manufacture of the conveyor chains and/or the carrier means, the necessary drive capacity that is to be provided can be considerably less than with prior known drag chain conveyors, as a result of which advantageously there is first of all a lower consumption of energy. Furthermore, smaller drive units also no longer require so much space, so that as a function of the mine conditions, the installations in face/section transition zones can be reduced, and the mine openings can also have appropriately smaller dimensions.

A further advantage is that the carrier means, due to their low specific weight, can have a larger cross-sectional design without this having significant effects upon the drive capacity that is to be provided, so that a drag chain conveyor equipped in this fashion can handle a larger conveying volume.

A further positive material property of polymeric material can be seen in the high material damping effect, as a result of which there can be advantageously achieved a good performance upon bending, torsion and the development of noise of the conveyor chains and carrier means that run in the conveyor chutes.

Pursuant to one specific embodiment of the drag chain conveyor of the present application, the carrier means can comprise a metallic casing that prescribes the external shape of the carrier means, whereby the inner space of the metallic casing is filled with the polymeric material. With such a design of the carrier means, it is already possible to achieve a considerable reduction in dead load.

To the extent that it is desired to produce the carrier means, and possibly also the conveyor chains, entirely of a polymeric material that is suitable for underground use, this polymeric material, with a view toward the required mechanical strength, can be a fibrous composite material or a carbon fiber reinforced polymeric material that has adequate mechanical characteristics, such as adequate impact strength, compressive strength, etc. The polymeric material can also be a thermoplastic cast material which, for example, can again be provided with fiber reinforcement.

Pursuant to one embodiment of the drag chain conveyor of the present application, the polymeric material that is to be used can be a crystalline, thermoplastic material, preferably a polymeric material that has come to be known by the designation Polyamide 6.

Further specific features of the present application will be described in detail subsequently.

### DESCRIPTION OF PREFERRED EMBODIMENTS

The drag chain conveyor of the present application comprises individual, interconnected conveyor chutes or troughs 10, in the lateral regions of which are guided two conveyor chains 11. Disposed between the conveyor chains 11 are carrier or engagement means 12 that are connected with the conveyor chains 11 and that during circulation in the conveyor chutes 10 take care of transport of the material that is to be conveyed away. At the end of the section comprised of the conveyor chutes 10, there is disposed a driving pulley 13 for the conveyor chains 11, whereby the driving pulley can be driven by a drive means, in the form of an electric motor 16, that is connected via an interposed tapered spur wheel gear mechanism 14 and a coupling or clutch means 15 that is disposed ahead of it.

The features of the subject matter of this application disclosed in the preceding specification, the claims and the abstract can be important individually and also in any desired combination for the realization of the invention in its various embodiments.

The specification incorporates by reference the disclosure of German priority document 100 20 021.4 filed 22 Apr. 2000.

The present invention is, of course, in no way restricted to the specific disclosure of the specification and drawing, but also encompasses any modifications within the scope of the appended claims.

We claim:

1. A drag chain conveyor for use in underground mining, comprising:
interconnected, profile conveyor chutes;
conveyor chains guided in said conveyor chutes;
carrier means attached to said conveyor chains, wherein at least one of said conveyor chains and said carrier means are comprised at least partially of a self-extinguishing and difficult to ignite polymeric material having anti-static material properties and a high mechanical strength; and
at least one drive means for said conveyor chains.

2. A drag chain conveyor according to claim 1, wherein said carrier means comprise a metallic casing that prescribes an external shape of said carrier means, and wherein an inner space of said metallic casing is filled with said polymeric material.

3. A drag chain conveyor according to claim 1, wherein said polymeric material is a fibrous composite material.

4. A drag chain conveyor according to claim 1, wherein said polymeric material is a carbon fiber reinforced material.

5. A drag chain conveyor according to claim 1, wherein said polymeric material is a thermoplastic cast material.

6. A drag chain conveyor according to claim 1, wherein said polymeric material is a crystalline thermoplastic material.

7. A drag chain conveyor according to claim 6, wherein said polymeric material is a Polyamide.
